(19) United States
(12) Patent Application Publication
(10) Pub. No.: US 2005/0241484 A1
(43) Pub. Date: Nov. 3, 2005

(54) Air filtration system

(76) Inventor: Glenn Wayne Hinds II, Leander, TX (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 10/514,671

(22) PCT Filed: Jun. 17, 2003
(86) PCT No.: PCT/US03/19330

§ 371 Date: Nov. 17, 2004

Related U.S. Application Data
(60) Provisional application No. 60/391,759, filed on Jun. 26, 2002.

(51) Int. Cl. B01D 47/00

(52) U.S. Cl. 96/236

(57) ABSTRACT

An air filtration system comprising: a tunnel; a bank of fans at the front which move air through the tunnel; a washing station for washing the air with droplets of hot water, cold water or both within the tunnel; a water precipitator for separating the water droplets from the air moving through the tunnel at the rear. A collection pond, water overflow weir and pond adjacent the rear of the tunnel allow for separation of pollutants from the water. The pollutants are periodically removed while the water is filtered, purified and water recirculated for re-use at the washing station; and a sediment removal device. This invention may further include a laser plasma component for incinerating particulates; an electromagnetic component for removing magnetic particles; and an acoustic energy device for further atomizing the water droplets.

### CROSS REFERENCE TO RELATED APPLICATIONS

The applicant claims the benefit of his PCT Application Ser. No. PCT/US03/19330, filed Jun. 17, 2003 which claims priority from his Provisional Application Ser. No. 60/391,759, filed Jun. 26, 2002.

### BACKGROUND OF THE INVENTION

The present invention relates to the field of air pollution control. More particularly, this invention relates to methods and apparatuses to remove a variety of pollutants from the air.

The severity of the current air pollution problem and the need for a new approach to pollution removal cannot be overstated. According to the U.S. Environmental Protection Agency (EPA), 4 out of every 10 Americans live in areas where the ambient air is often unhealthy to breathe. According to the U.S. Congressional Office of Technology Assessment, tens of thousands die prematurely every year in the U.S.A. and Canada because of respiratory or cardiac problems attributed to air pollution. According to the California South Coast Air Quality Management District, 1 in 10 people are extremely vulnerable to particulates from smokestacks, chimneys, diesel exhaust, blowing dust, etc. These particulates, which hang in the atmosphere to form a haze, are linked to cancer and present an extreme health threat to respiratory-impaired people.

The magnitude of pollutants released into our atmosphere yearly is staggering. In addition to the emissions from millions of motor vehicles, billions of pounds of toxic air pollutants are also released annually into the skies above North America. This ongoing fouling of our air manifests itself by triggering a host of destructive processes. Acid rain caused by air pollution threatens lakes in many states. Chlorofluorocarbons destroy the earth's protective ozone layer, which increases the amount ultraviolet radiation hitting the earth. Increased ultraviolet radiation causes millions of new skin cancer cases per year. Looming ominously ahead is the atmospheric greenhouse effect caused by air pollution. Many predict that this could lead to catastrophic droughts, and melting of glaciers and the polar ice caps leading to subsequent flooding of coastal areas.

A wide variety of air pollution control devices or air cleaning machines are already in use. Exemplary of such air pollution control devices are electrostatic precipitators, fabric filters and other filtration machines, wet scrubbers, mechanical particulate collectors, sorption process machines, vehicle pollution control devices, etc. The existing pollution control devices and methods are directed towards attempting to prevent pollutants from entering the atmosphere at a specific source or towards clean up efforts. Prior conventional pollution control techniques do nothing to remove particulates, such as dust, which are a product of man's activities rather than produced by any particular machine and process.

The source control approach is clearly not working. The quality of our air continues to worsen. In fact the EPA is now considering how to remove particulates. What is needed is an entire rethinking of modern air pollution control strategies.

There exists, therefore, an urgent need for an air cleaning system which can remove pollutants, which are present for whatever reason, from the air on a large scale. Development of an air cleaning system which can remove pollutants from the air on a large scale represents a great improvement in the field of pollution control and satisfies a long felt need of the pollution control engineer and the public at large.

### SUMMARY OF THE INVENTION

The present invention is an air filtration system comprising s tunnel with a fan or a bank of fans at the front. Within the tunnel there is a washing station for washing the air with droplets of hot water, cold water, steam or all. Within the tunnel at the rear there is a water precipitator for separating the water droplets from the air moving through the tunnel. Adjacent the rear of the tunnel is a collection pond, with a water overflow weir at its rear. Adjacent the weir is a pond. A water recirculating system is attached between the pond and the washing station. There is also a sediment removal device.

The fan or fans move polluted air through the tunnel where the water droplets trap pollution and the water precipitator separates the polluted water droplets from the air moving through the tunnel. This creates a quantity of polluted water, which is collected in the collection pond. In the collection pond the pollutants settle out to form a sediment with an over layer of clear water. The clear water flows over the weir into the pond where it is recirculated back to the washing station with appropriate filtering and purifying. The sediment removal device is used periodically for removing the sediment from the collection pond.

This invention may further include a laser plasma component for incinerating particulates; an electromagnetic component for removing magnetic particles; and an acoustic energy device for further atomizing the water droplets; and a second steam misting station.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is an overall, perspective view of one embodiment of this invention.

FIG. 1A is a close up view of one of the air moving fans of this invention.

FIG. 2 is a front elevational view of the water washing element of this invention.

FIG. 2A is a close up view of a spray head.

FIG. 3 is an overall, perspective view of a second embodiment of this invention.

FIG. 4 is a perspective illustration of the tunnel, and the water precipitating components of this invention.

FIG. 5 is a schematic diagram of one arrangement of the pollution treating components of this invention.

FIG. 6 is a schematic diagram of a second arrangement of the pollution treating components of this invention.

FIG. 7 is a schematic diagram of a third arrangement of the pollution treating components of this invention.

FIG. 8 is a front, elevational view of the negative ion grid of this invention.

FIG. 8A is a close up view of the negative ion grid system of this invention illustrating ionization of particles in the polluted air.

FIG. 9 is a view of the wind and rain tunnel alone illustrating the insert access door and guide channels.

FIG. 10 is a front perspective view of the steam injection insert component of this invention.

FIG. 10A is a close up of a steam mister.

FIG. 11 is a front perspective view of the laser plasma insert component of this invention.

FIG. 12 is a front perspective view of the electromagnetic coil generator insert component of this invention.

FIG. 13 is a front perspective view of the acoustic energy field insert component of this invention.

FIG. 14 is a partial perspective view of this invention illustrating a protective screen, service platform and elevators.

FIG. 15 is a front perspective view of an exhaust security screen.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

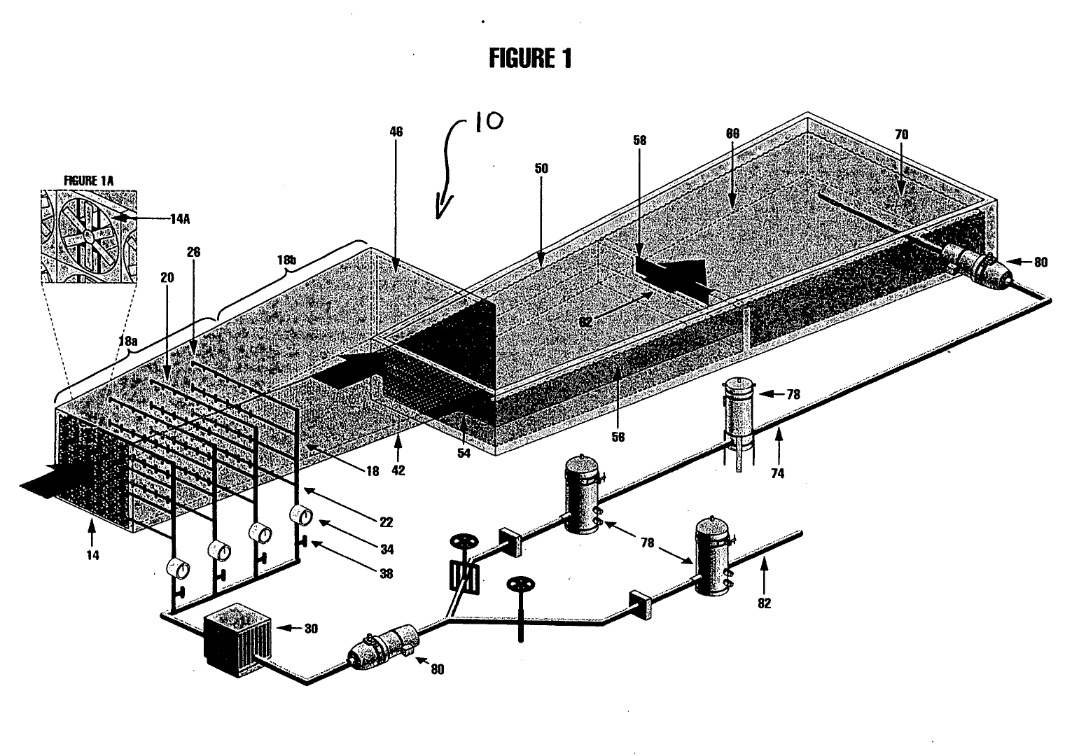

Everyone has noticed that pollution is practically non-existent after it has rained. This is because the water droplets dissolve gaseous pollutants and entrain particulate pollutants. This invention is based, in part, on the well known phenomenon of removal of air pollution with droplets of water. FIG. 1 is an overall, perspective view of one embodiment 10 of this invention. At the front end of this invention is a single fan or a bank of air moving fans 14. Design and construction of such fans is well known in the pollution control industry. An enlarged view of one fan 14a is illustrated in FIG. 1A. The purpose of the bank of fans 14 is to draw polluted air into the invention.

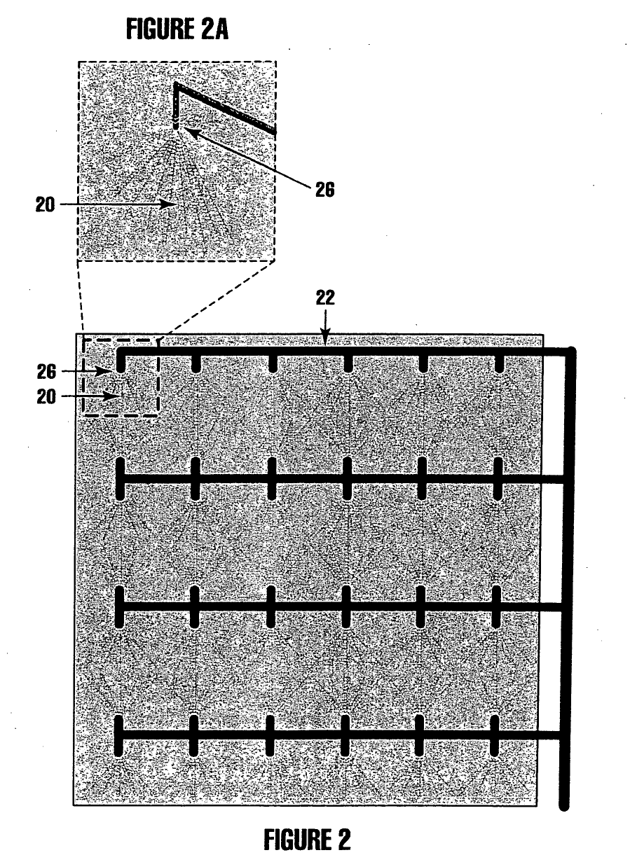

The polluted air is drawn into a tunnel 18 which may be thought of as divided into several zones 18a, 18b. In the first zone 18b, closest to the fans 14, the polluted air is exposed to a spray of water 20 via one or more manifolds 22 with spray nozzles 26. FIG. 2 is a front elevational view of one such water misting or water washing manifold 22. FIG. 2A is a close up view of a water misting head or spray nozzle 26. Spray nozzles 26 are provided which provide a fine spray 20. The water provided to the manifold 22 may be heated to hot water or steam, or chilled via a heating or cooling system 30. Chilling may be desirable if this invention is operated in a particularly hot environment while heating may be desirable if this invention is operated in a particularly cold environment. This will affect the temperature of the air exiting the rear 46 of the tunnel 14. Flow meters 34 and valves 38 may be incorporated into each manifold 22 for monitoring, maintenance and adjustment purposes. Pollutants are dissolved and entrained in the water droplets 20 as the air passes through the manifolds 22. Typically, not all of the pollutants will be removed with a single washing. Therefore, the invention will preferably include a number of manifolds 22. The number is adjusted so that the maximum amount of pollution is removed from the air.

Most of the water droplets 20 agglomerate and fall to the bottom 42 of the tunnel 18 which is slanted downwards towards the rear 46 so that the water flows away from the fans 14 and further into the tunnel 18. Some of the water droplets 20 will become a fine mist which will not fall immediately. The second zone 18b of the tunnel 18 is designed to allow a space for this fine mist 20 to agglomerate and settle to the bottom 42.

The air, which is now cleansed of pollutants, exits the rear 46 of the tunnel 18. All of the water, which now contains particulate and dissolved pollution, runs along the bottom 42 of the tunnel 18 and drains into a settling pond 50. In the settling pond 50, the solid pollutants settle to form a sediment 54, which can be periodically removed by well known methods and disposed of in accordance with applicable regulations.

As the settling pond 50 fills, the supernatant water 56 flows over a weir 58 at the rear 62 of the settling pond 50 and into a collecting pond 66. The water 70 in the collecting pond is recycled for use in the water misting manifolds 22. Appropriate return piping 74 and pumps 80 are provided for this purpose. Preferably, the recycled water 70 is filtered and purified prior to re-use. Appropriate filters and purifiers 78 are provided for this purpose. There is also a make up line 82, with an optional purifier 78, connected to the public water main or other source of fresh water, to add water to the system. The additional water is needed to make up system water losses due to evaporation and removal with the sediment 54.

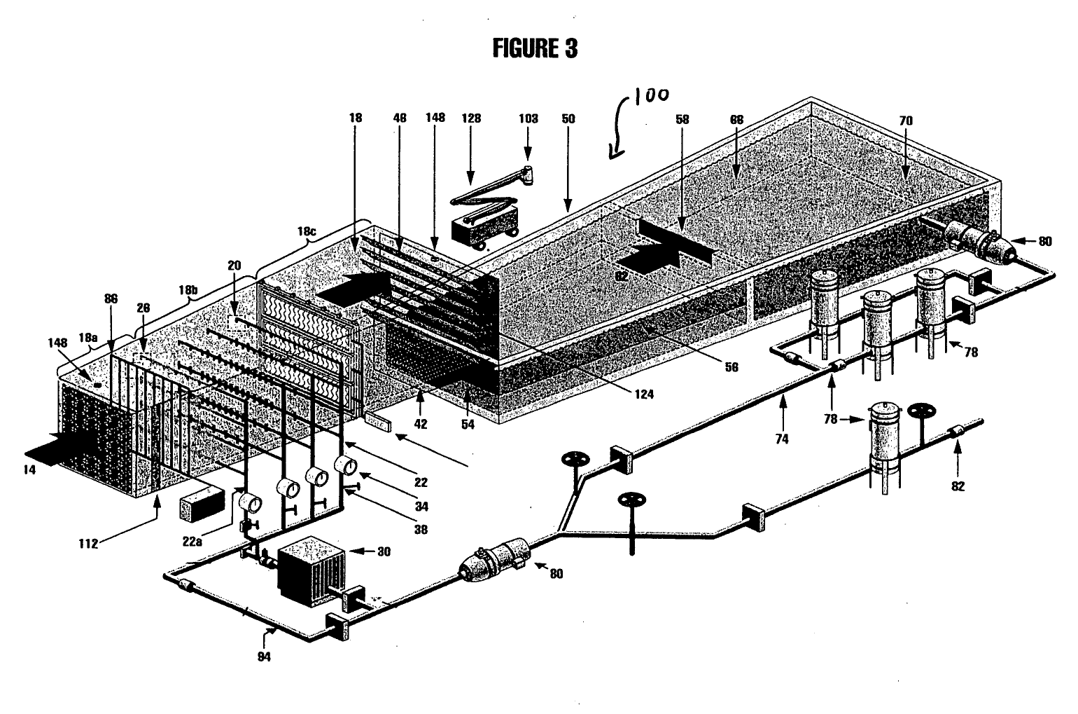

FIG. 3 is an overall, perspective view of a second embodiment 100 of this invention. The second embodiment 100 is similar to the first 10. At the front end of this invention is a single or bank of air moving fans 14. Design and construction of such fans is well known in the pollution control industry. The purpose of the bank of fans 14 is to draw polluted air into the invention.

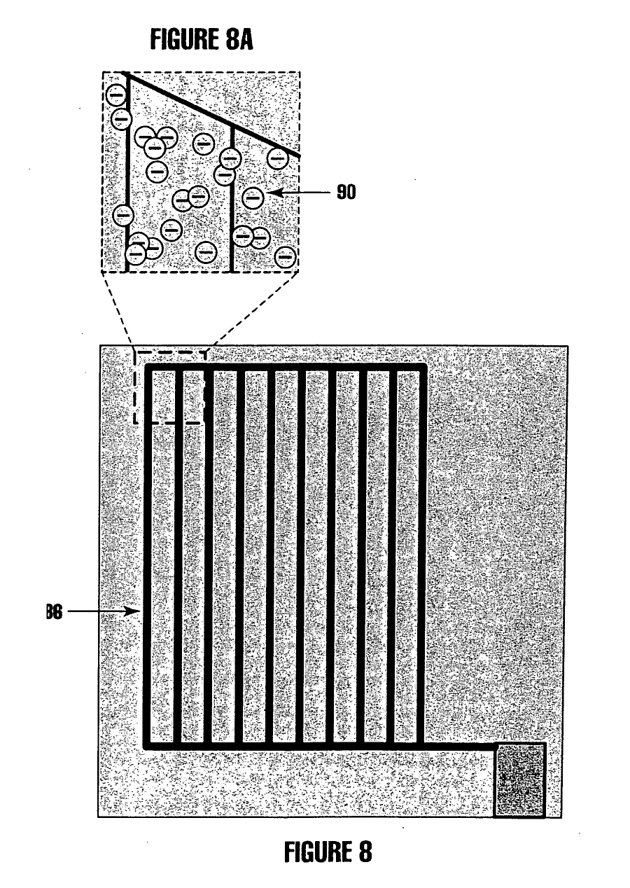

The polluted air is drawn into a tunnel 18 which may be thought of as divided into several zones 18a, 18b, 18c. In the first zone 18a, closest to the fans 14, the polluted air is ionized by a grid 86 that is ionized with negative charge. FIG. 8 is a front, elevational view of the negative ion grid 86 of this invention. FIG. 8A illustrates how the particles 90 in the air become negatively ionized as they pass through the grid 86.

In the next zone 18b the polluted air is exposed to a spray 20 of water via one or more manifolds 22 with spray nozzles 26. FIG. 2 is a front elevational view of one such water misting manifold 22. FIG. 2A is a close up view of a water misting head or spray nozzle 26. Spray nozzles 26 are provided which provide a fine spray 20. The water provided to the manifold 22 may be heated to hot water or steam, or chilled via a heating or cooling system 30. Chilling may be desirable if this invention is operated in a particularly hot environment while heating may be desirable if this invention is operated in a particularly cold environment. This will affect the temperature of the air exiting the rear 46 of the tunnel 14. FIG. 3 illustrates a case where one manifold 22a is provided with heated water while the remaining manifolds 22 are provided with water at ambient temperature. In this case incoming water is heated with a heater 30 and a bypass loop 94 is provided to bypass the heater 30 and provide ambient temperature water to the other manifolds 22. Typically, not all of the pollutants will be removed with a single washing. Therefore, the invention will preferably include a number of manifolds 22. The number is adjusted so that the maximum amount of pollution is removed from the air.

Flow meters 34 and valves 38 may be incorporated into each manifold 22 for monitoring, maintenance and adjustment purposes. Those most familiar with the art to which this invention pertains will recognize that, of course, pollution is dissolved and entrained in the water droplets 20 as the air passes through the manifolds 22. Ionization of the incoming particles 90 increases attraction of the particles 90 to the water droplets 20 thus increasing the percentage of particles 90 that are entrained.

Most of the water droplets 20 agglomerate and fall to the bottom 42 of the tunnel 18 which is slanted downwards towards the rear 46 so that the water flows away from the fans 14 and further into the invention. Some of the water droplets 20 will become a fine mist which will not agglomerate and fall immediately. The third zone 18c of the tunnel 18 is designed to allow a space for this fine mist 20 to agglomerate and settle to the bottom 42.

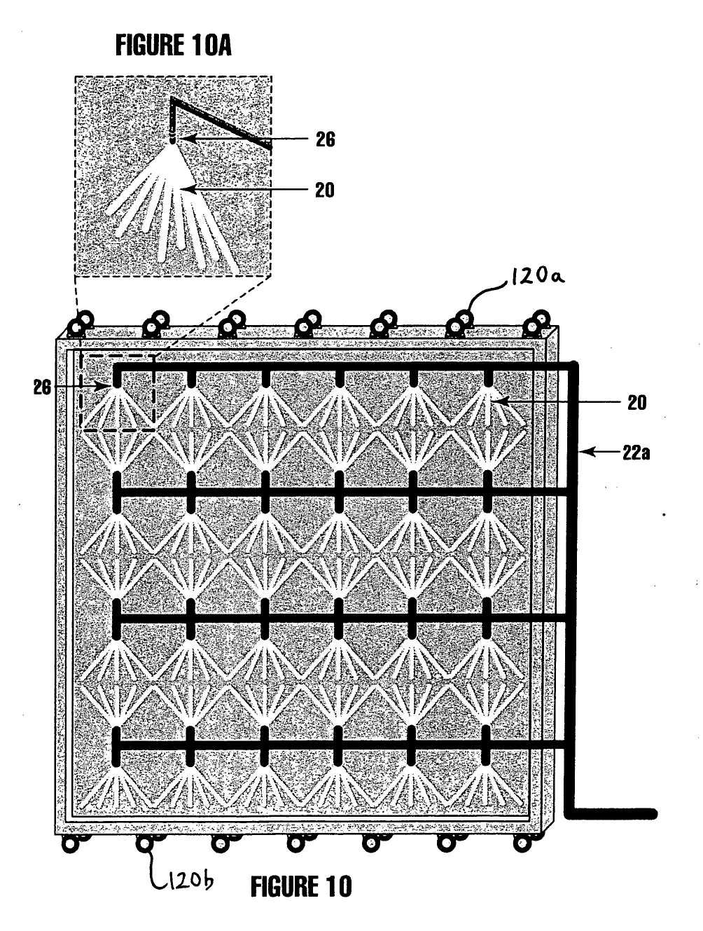

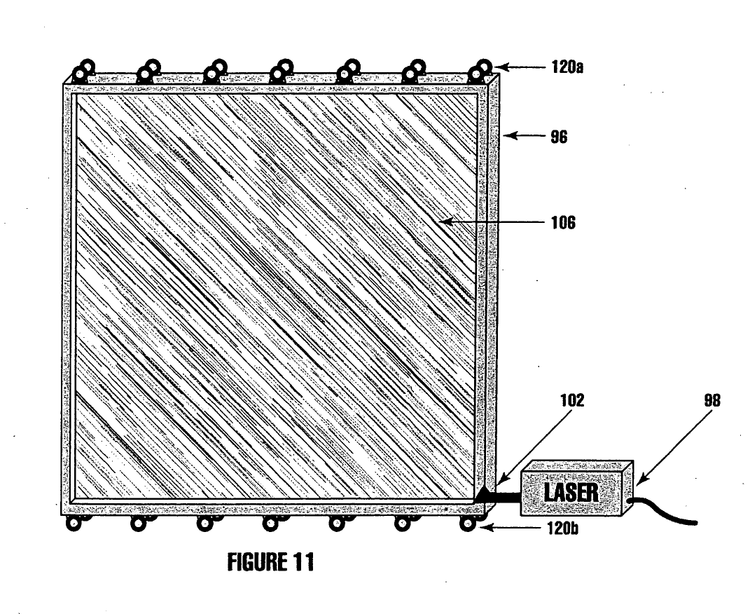

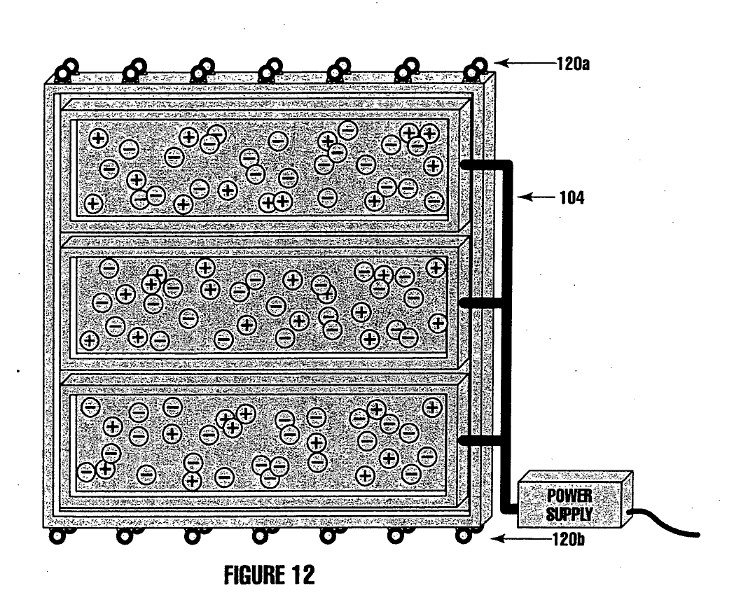

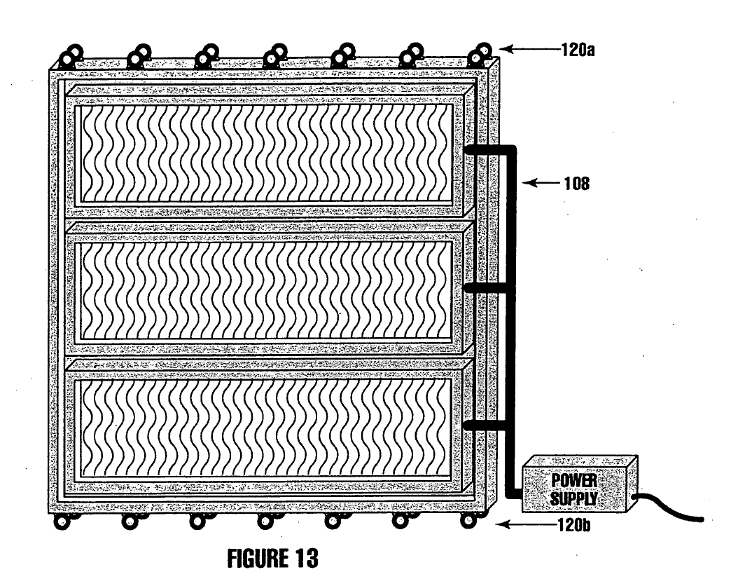

There may be positioned within the tunnel 18 one or more devices to enhance removal of particles 90 or dissolution of pollutants by the mist 20. FIG. 10 is a front perspective view of a steam manifold 22a of this invention. FIG. 10A is a close up of a steam mister 26a. FIG. 11 is a front perspective view of a laser insert component 96 of this invention. The laser insert 96 comprises a laser 98 and prism 104 arranged to provide a planar laser field 106. The laser 98 is selected so that the field 106 will incinerate particles 90. FIG. 12 is a front perspective view of an electromagnetic coil generator insert component 104 of this invention. The electromagnetic field will attract and retain magnetic particles 90. FIG. 13 is a front perspective view of an acoustic energy field insert component 108 of this invention. This component 108 incorporates one or more sealed speakers driven at ultrasonic frequencies. The acoustic field so produced super atomizes the water 20 and enhances the ability of the water 20 to dissolve and retain the pollutants.

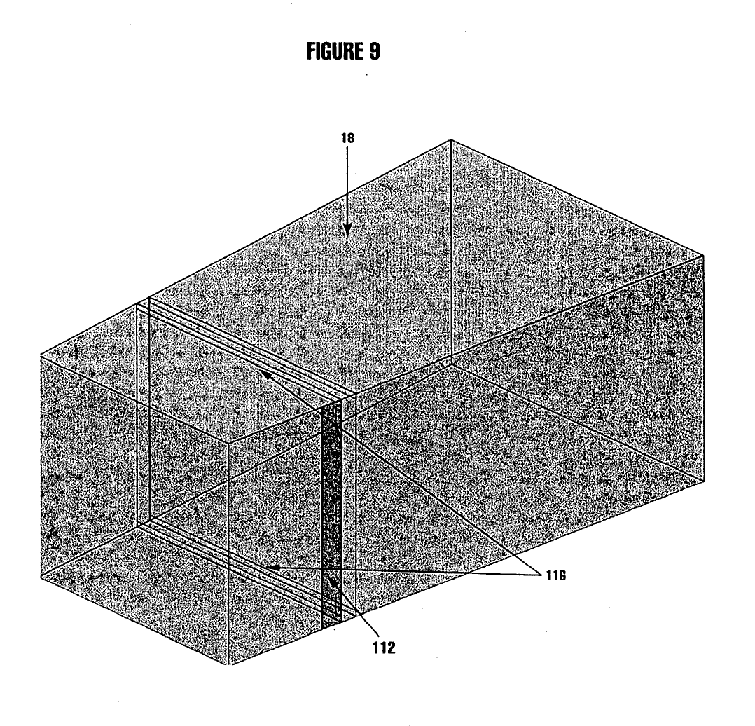

The components 22a, 96, 104, 108 illustrated in FIGS. 10, 10A, 11, 12 and 13 may be installed depending on the kind of pollution that may be encountered in a particular location. To enable these inserts 22a, 96, 104, 108 to be installed and removed as needed, an access door 112 is provided in the tunnel 18. One location for such a door 112 is shown in FIG. 3. A clearer illustration is shown in FIG. 9. In the interior of the tunnel 18 there are tracks 116. Since each of the components 22a, 96, 104, 108 may be provided with top 120a and bottom 120b wheels, these components 22a, 96, 104, 108 may be inserted and removed as needed.

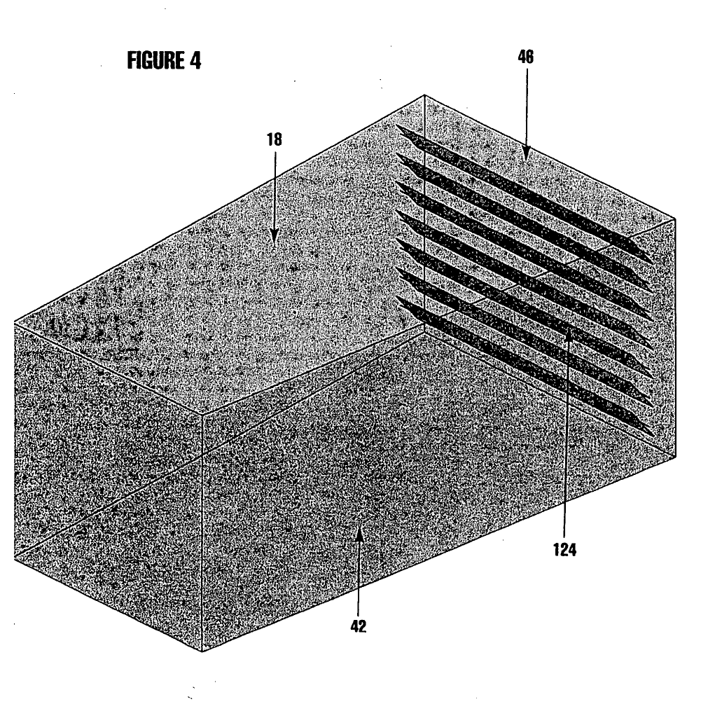

A bank of downward slanting vanes 124 is positioned at the rear 46 of the tunnel 18 in order to ensure that water droplets 20 fall to the bottom 42. For clarity, FIG. 4 is a perspective illustration of the wind and rain tunnel 18, and the vanes 124 of this invention.

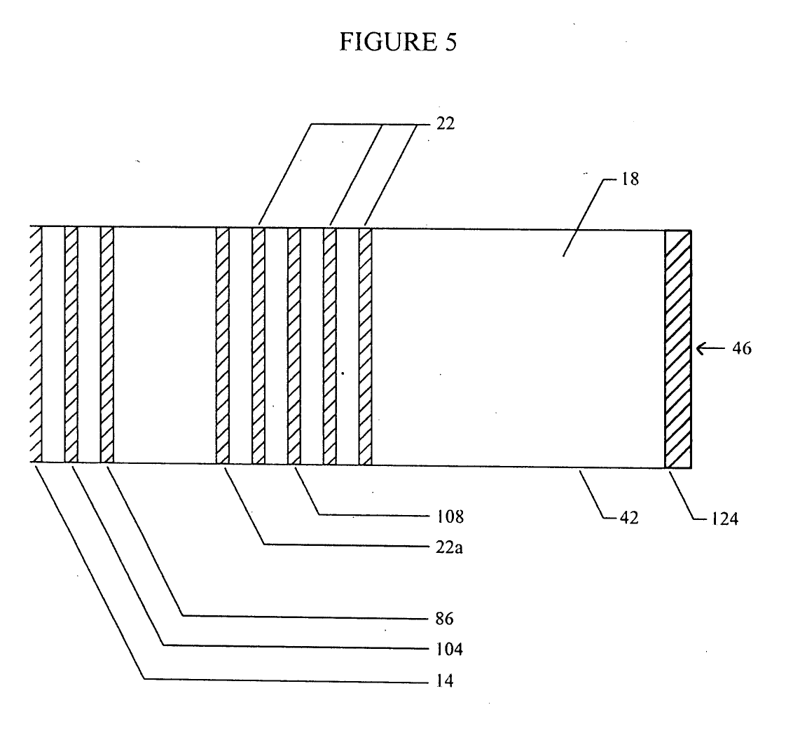

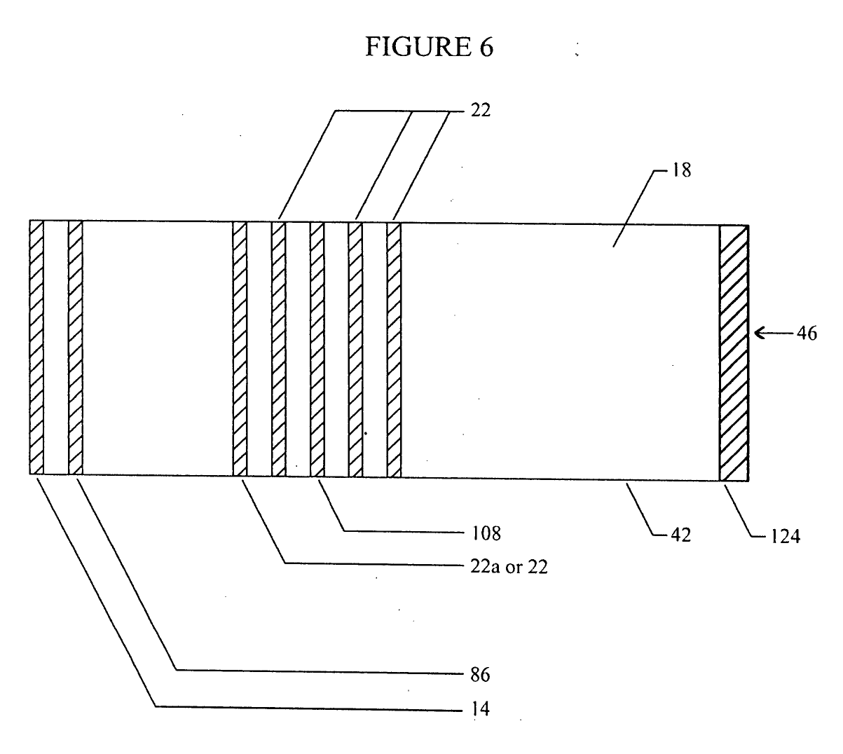

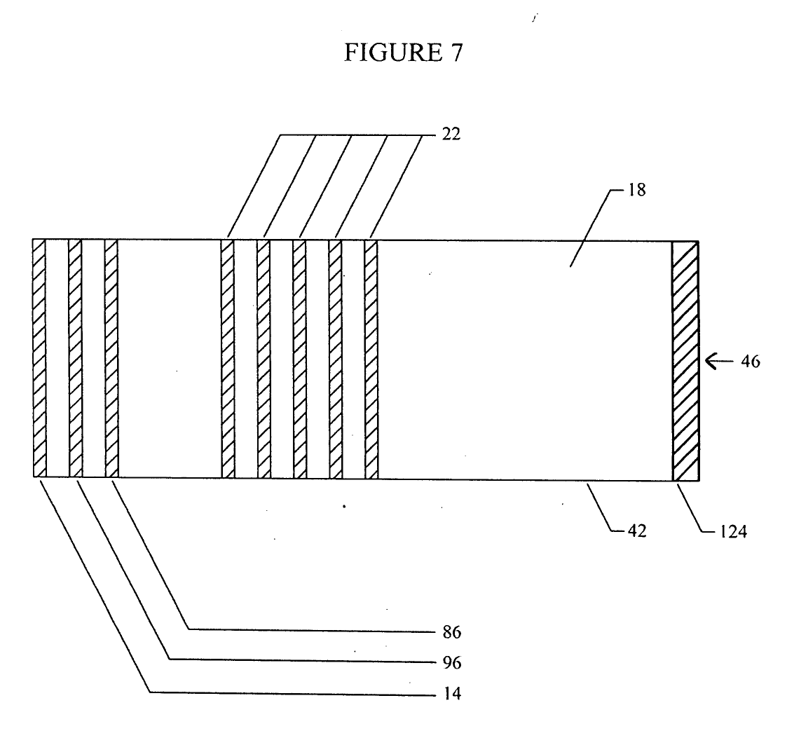

It will be obvious to those most familiar with the art to which this invention pertains that this invention may be assembled in many different configurations to accommodate the pollution experienced in a given area. FIGS. 5, 6 and 7 are illustrative of some of the ways the different components of this invention may be assembled. FIG. 5 illustrates an assembly having an electromagnetic coil 104, an ionization grid 86 a steam mister 22a, a water mister 22, an acoustic energy field 108 and two final banks of water misters 22. FIG. 6 illustrates an assembly having an ionization grid 86 a steam mister 22a or hot water mister 22, a water mister 22, an acoustic energy field 108 and two final banks of water misters 22. FIG. 7 illustrates an assembly having a laser insert 96, an ionization grid 86 and four banks of water misters 22.

The air, which is now cleansed of pollutants, exits the rear 46 of the tunnel 18. The water runs along the bottom 42 of the tunnel 18 and drains into a settling pond 50. In the settling pond 50, the solid pollutants settle to form a sediment 54, which can be periodically removed by well known methods and disposed of in accordance with applicable regulations. FIG. 3 illustrates one method: a hydraulic arm sediment pump 128.

As the settling pond 50 fills, the supernatant water 56 flows over a weir¹ 58 at the rear 62 of the settling pond 50 and into a collecting pond 66. The water 70 in the collecting pond 66 is recycled for use in the water misting manifolds 22. Appropriate return piping 74 and pumps 80 are provided for this purpose. The recycled water 70 may need to be filtered and purified prior to re-use. There is also a make up line 82, with an optional purifier 78, connected to the public water main or other source of fresh water, to add water to the system. The additional water is needed to make up system water losses due to evaporation and removal with the sediment 54.
1 A weir is defined as an obstruction or dam placed in a stream to raise the water and, divert it into a millrace or irrigation ditches, etc.

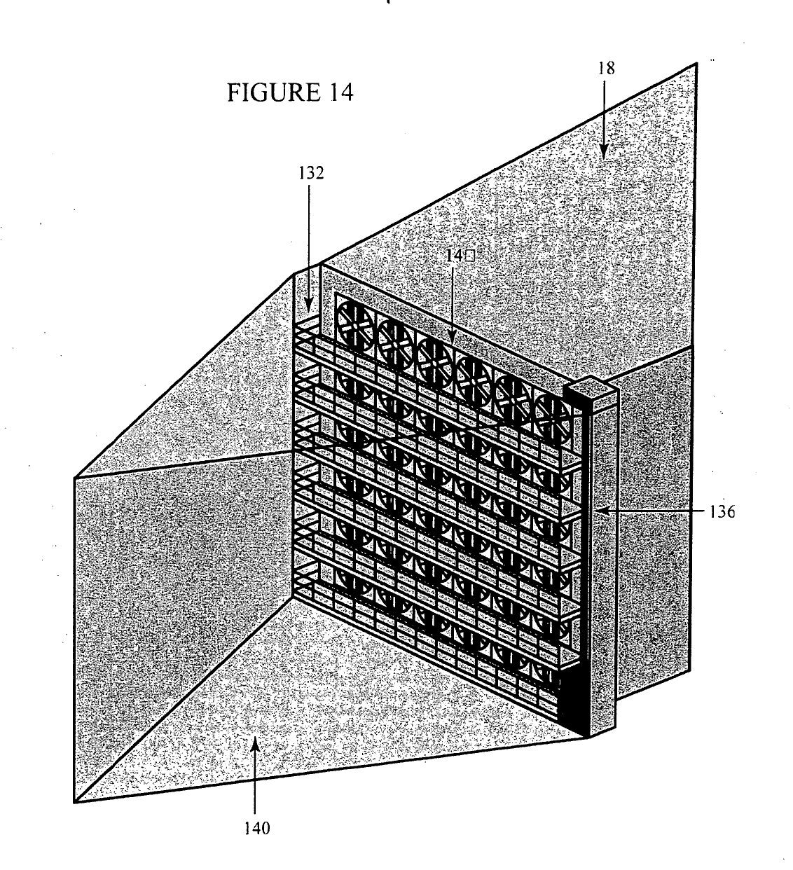

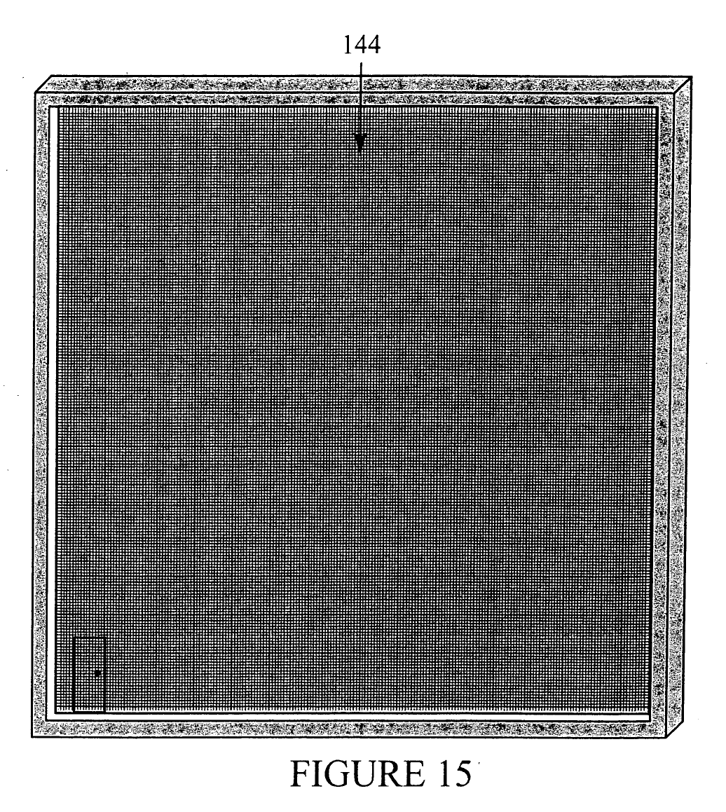

The size of this invention will depend on the concentration of pollution experienced in a given location. Because of its unique design, this invention can be used to cleanse cubic miles of air per day making it fairly massive. Typically, it will require platforms 132 and elevators 136 to service the fans 14. Also protective screening 140 may be required. FIG. 14 is a partial perspective view of this invention illustrating a front protective screen 140, service platform 132 and elevators 136. FIG. 15 is a front perspective view of an exhaust security screen 144. The security screen may be necessary to prevent unauthorized access to the invention.

It is intended to install a network of the above described units all over the country, with concentration in areas having the greatest pollution. Each individual unit will be designed, as described above, to treat local pollution conditions. Fan speed and the individual components used are the major variables that can be adjusted to accommodate local pollution conditions. If pollution conditions change, some components of the invention can be changed as described above. To enable more efficient operation, pollution monitors 148 may be installed in the tunnel 18 to monitor the condition of the incoming and outgoing air. Suitable pollution monitors 148 are available from SICK, Inc., 6900 West 110th Street, Bloomington, Minn. 55438, or Pem-Tech, Inc., 10808 Fallstone Road, Suite 325, Houston, Tex. 77099.

The following reference numerals are used on FIGS. 1 through 15:

10 First embodiment of invention

14 Bank of fans

18 Tunnel

22 Manifold

22a Hot water manifold

26 Spray nozzle

30 Water heater or chiller

34 Flow meter

38 Valve

42 Bottom of tunnel

46 End of tunnel

50 Settling pond

54 Sediment

58 Weir

62 End of settling pond

66 Collecting pond

70 Recycled water

74 Return piping system

78 Filter or purifier

80 Pump

82 Fresh water inlet piping

86 Ionization grid

90 Particles

94 Bypass loop

96 Laser insert

98 Laser generator

100 Second embodiment of invention

102 Beam splitting prism

104 Electromagnetic insert

106 Laser field

108 Acoustic energy insert

112 Insert access door

116 Guide tracks

120a Top guide wheel

120b Bottom guide wheel

124 Vanes

132 Service platform

136 Service elevator

140 Protective screen

144 Exhaust security screen

Thus, the present invention has been described herein with reference to a several embodiments 10, 100 for particular applications. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. An air filtration system comprising:
(a) a tunnel means for housing said air filtration system;
(b) an air moving means for moving air polluted with particulate and gaseous pollutants through said tunnel means;
(c) a washing means for washing said air with water droplets, whereby said pollutants become trapped in said water droplets and are removed from said air,
(d) a horizontal vane means for precipitating said water droplets, thereby creating a quantity of polluted water;
(e) a collection pond means for collecting said quantity of polluted water; said particulate pollutants dropping to the bottom of said collection pond; whereby a sediment layer of pollutants at the bottom and clear water layer at the top are produced;
(f) a water separator means for separating said clear water layer from said sediment layer;
(g) a water recirculating means for filtering, purifying and recirculating said clear water from said pond to said washing means; and
(h) a sediment removal means for periodically removing said sediment from said collection pond means.

2. An air filtration system as claimed In claim 1 further comprising a laser means for incinerating particulates.

3. An air filtration system as claimed in claim 1 further comprising an electromagnetic means for removing magnetic particles.

4. An air filtration system as claimed in claim 1 further comprising an acoustic energy means for atomizing said water droplets.

5. An air filtration system as claimed in claim 1 further comprising a steam washing means for washing said air with steam.

6. An air filtration system as claimed in claim 1 in which said water is selected from the group consisting of hot water, steam, chilled water and any combination of hot water, steam and chilled water.

7. An air filtration system comprising:
(a) a tunnel means for housing said air filtration system;
(b) an air moving means for moving air polluted with particulate and gaseous pollutants through said tunnel means;
(c) a pollution sensing means for quantifying the pollutants contained in said air;
(d) an ambient water washing means for washing said air with droplets of water at ambient temperature; whereby said pollutants become trapped by droplets of water;
(e) a horizontal vane means for separating said water droplets from the air moving through said tunnel means; thereby creating a quantity of polluted water;
(f) a collection pond means for collecting said quantity of polluted water; particulate pollutants dropping to the bottom of said collection pond; whereby a sediment layer of said particulate pollutants at the bottom and a clear water layer at the top are created;
(g) a pond means for collecting said clear water;
(h) a water overflow means for allowing said clear water to flow into said pond means while retaining said sediment layer in said collection pond means;
(i) a water recirculating means for recirculating said clear water from said pond to said water washing means and said ambient water washing means;
(j) a filter means for filtering and purifying said clear water, incorporated in said water recirculating means; and
(k) a sediment removal means for periodically removing said sediment from said collection pond means.

8. An air filtration system as claimed in claim 5 further comprising a laser means for incinerating particulates.

9. An air filtration system as claimed in claim 5 further comprising an electromagnetic means for removing magnetic particles.

10. An air filtration system as claimed in claim 5 further comprising an acoustic energy means for atomizing said water droplets.

11. An air filtration system as claimed in claim 1 further comprising a steam washing means for washing said air with steam.

12. An air filtration system as claimed in claim 1 further comprising a negative ion generating means for ionizing particulates.

13. An air filtration system as claimed in claim 1 further comprising a water washing means for washing said air with water selected the group consisting of hot water and steam, whereby said pollutants become trapped in droplets of water.

14. An air filtration system comprising:
(a) a tunnel having a front and a rear;
(b) a fan, located at the front of said tunnel;
(c) an ambient water washing subsystem, located within said tunnel, adjacent said fan, whereby said pollutants become trapped by droplets of water;
(d) a horizontal vane, located within said housing, adjacent said ambient water washing system, whereby a quantity of polluted water is created;
(e) a collection pond, located adjacent to the rear of said housing, adapted for collecting said quantity of polluted water; particulate pollutants dropping to the bottom of said collection pond; whereby a sediment layer of particulate pollutants at the bottom and clear water layer at the top are created;
(f) a pond, located adjacent said collection pond;
(g) a flow means for allowing said clear water to flow into said pond while retaining said sediment layer in said collection pond
(h) a water recirculating subsystem connected between said pond and said ambient water washing subsystem;
(i) a filter incorporated within said water recirculating subsystem; and
(j) a sediment removal means.

15. An air filtration system as claimed in claim 14 further comprising a pollution sensor, located within said tunnel.

16. An air filtration system as claimed in claim 14 in which said flow means is a weir between said collection pond and said pond.

17. An air filtration system as claimed in claim 14 further comprising a laser subsystem, adapted to be located within said tunnel and to Incinerate particulates.

18. An air filtration system as claimed In claim 14 further comprising an electromagnetic subsystem, adapted to be located within said tunnel and to remove magnetic particles.

19. An air filtration system as claimed in claim 14 further comprising an acoustic energy subsystem, adapted to be located within said tunnel and to atomize said water droplets.

20. An air filtration system as claimed in claim 14 further comprising a steam washing subsystem, adapted to be located within said tunnel and to wash said air with steam.

21. An air filtration system as claimed in claim 14 further comprising a negative ion generator, located within said tunnel, adapted for ionizing particulate pollutants.

22. An air filtration system as claimed in claim 14 further comprising a water washing subsystem, located within said tunnel, adapted for washing said polluted air with water selected from the group consisting of hot water and steam; whereby said pollutants become trapped in said water, said water cooling to water droplets as it passes through said tunnel.

23. A method of removing pollutants from air polluted with particulate and gaseous pollutants comprising the steps of:
(a) washing said polluted air with droplets of water at ambient temperature; whereby pollutants become trapped by said droplets of water;
(b) separating said water droplets from said air with a horizontal vane; thereby creating a quantity of polluted water;
(c) collecting said quantity of polluted water,
(d) allowing said quantity of polluted water to settle; whereby a sediment later of particulate pollutants at the bottom and clear water layer at the top are created;
(e) separating said clear water from said sediment;
(f) filtering and purifying said clear water;
(g) recirculating said clear water to be used in said washing steps; and
(h) periodically removing said sediment.

24. A method as claimed in claim 23 further comprising the step of incinerating said particulates.

25. A method as claimed in claim 23 further comprising the step of removing magnetic particles.

26. A method as claimed in claim 23 further comprising the step of further atomizing said water droplets.

27. A method as claimed in claim 23 further comprising the step of ionizing particulates in said air.

28. A method as claimed in claim 23 further comprising the step of washing said air with water selected from the group consisting of hot water and steam; whereby pollutants become trapped in said steam, which cools to water droplets;

29. A method as claimed in claim 28 further comprising the step of further washing said air with steam.

30. A method of removing pollutants from air polluted with particulate and gaseous pollutants comprising the steps of:
(a) providing a tunnel having a front and a rear;
(b) moving said polluted air through said tunnel from front to rear;
(c) providing a pollution sensor within said tunnel;
(d) quantifying the pollution in said polluted air by means of said pollution sensor;
(e) providing an ambient water washing station within said tunnel;
(f) washing said polluted air with droplets of water at ambient temperature in said ambient water washing station; whereby said pollutants become trapped by said droplets of water;
(g) providing a horizontal separating station within said tunnel adjacent said ambient water washing station;
(h) separating said water droplets from the air moving through said tunnel in said horizontal separating station; thereby creating a quantity of polluted water;
(i) providing a collection pond adjacent the rear of said housing;
(j) collecting said quantity of polluted water in said collection pond; particulate pollutants dropping to the bottom of said collection pond; whereby a sediment layer of pollutants at the bottom and clear water layer at the top are created;
(k) providing a pond adjacent said collecting pond;
(l) providing a weir between said collection pond and said pond; said weir designed and located to allow said clear water to flow into said pond while retaining said sediment layer in said collection pond;
(m) filtering and purifying said clear water;
(n) recirculating said clear water from said pond to said ambient water washing station;
(o) providing a sediment removal means; and
(p) periodically removing said sediment from said collection pond.

31. A method as claimed in claim 30 further comprising the steps of:
(a) providing a laser means for incinerating particulates within said tunnel; and
(b) incinerating particulates.

32. A method as claimed in claim 30 further comprising the steps of:
(a) providing electromagnetic means for removing magnetic particles within said tunnel; and
(b) removing magnetic particles.

33. A method as claimed in claim 30 further comprising the steps of:
(a) providing an acoustic energy means for atomizing said water droplets within said tunnel; and
(b) atomizing said water droplets.

34. A method as claimed in claim 30 further comprising the steps of:
(a) providing an ionizing grid within said tunnel; and
(b) ionizing particulates in said polluted air within said tunnel.

35. A method as claimed in claim 30 further comprising the steps of:
(a) providing a water washing station within said tunnel; and
(b) washing said air with water selected from the group consisting of hot water and steam in said washing station; whereby pollutants become trapped in said water, which cools to water droplets as It passes through said housing.

36. A method as claimed in claim 35 further comprising the steps of:
(a) providing steam washing means within said tunnel; and
(b) further washing said polluted air with steam.
